(19) United States
(12) Patent Application Publication
(10) Pub. No.: US 2017/0196748 A1
(43) Pub. Date: Jul. 13, 2017

(54) OPERATING TABLE AND FLOOR PLATFORM FOR AN OPERATING TABLE

(71) Applicant: MAQUET GMBH, RASTATT (DE)

(72) Inventor: Immanuel GAISER, Durmersheim (DE)

(73) Assignee: MAQUET GMBH, RASTATT (DE)

(21) Appl. No.: 15/469,072

(22) Filed: Mar. 24, 2017

Related U.S. Application Data
(63) Continuation-in-part of application No. PCT/EP2015/073901, filed on Oct. 15, 2015.

(30) Foreign Application Priority Data
Oct. 31, 2014 (DE) 10 2014 115 901.2

(51) Int. Cl. A61G 13/04; A61G 13/08; A61G 13/06

(52) U.S. Cl. CPC A61G 13/04; A61G 13/06; A61G 13/08

(57) ABSTRACT

An operating table floor platform is disclosed. The operating table floor platform has an omnidirectional drive assembly, which is configured so that the operating table floor platform is movable and rotatable by the omnidirectional drive assembly in any direction within a predetermined plane. The operating table floor platform also has a controller configured to control the omnidirectional drive assembly. The controller includes a manual actuation member. The controller includes a regulator that, based on the actuation of the manual actuation member, determines and sends control signals to the omnidirectional drive assembly.

### CROSS REFERENCE TO RELATED APPLICATIONS

The present application is a continuation-in-part filed under 35 U.S.C. §111(a), and claims the benefit under 35 U.S.C. §§365(c) and 371 of PCT International Application No. PCT/EP2015/073901, filed Oct. 15, 2015, and which designates the United States of America, and German Patent Application No. 10 2014 115 901.2, filed Oct. 31, 2014. The disclosures of these applications are herein incorporated by reference in their entirety.

### TECHNICAL FIELD

The disclosure relates to a floor platform for an operating table. The floor platform may comprise an interface for securing a patient support unit for supporting a patient. The disclosure further relates to an operating table that may comprise a floor platform and a patient support unit secured to the interface of the floor platform.

### BACKGROUND

Mobile operating tables are typically configured with floor platforms having a plurality of non-powered, passive wheels, at least some of which can swivel. The movement of the table and the control of the direction in which the operating table is moved are typically carried out entirely manually, with forces being exerted by the person moving the table.

Also known are operating tables that comprise a powered drive roller, which is typically driven by an electric motor. The alignment of this driven roller is typically fixed. The floor platform has a plurality of passively driven swivel castors, and the direction of movement of the floor platform is changed by an operator, who must apply suitable force to accomplish this. The driven roller thus serves as a supporting drive.

### SUMMARY OF THE DISCLOSURE

In at least some exemplary embodiments, a floor platform and an operating table can be moved easily and intuitively controlled.

In at least some exemplary embodiments, the floor platform may have an omnidirectional electrical drive unit, which may be configured in such a way that the floor platform can be moved and rotated, by this electrical drive unit (e.g., moved alone) within a predetermined plane and in any direction.

A control unit may regulate the drive unit. This control unit may comprise a manual actuation element and a regulator which, in accordance with the actuation of the actuation element, may determine control signals (e.g., trigger signals) for the drive unit and may send them to the drive unit, on the basis of which the drive unit may then move and/or rotate the floor platform in accordance with the movement specified by the actuation element.

Trigger signals may include, for example, data, signals and/or information sent by the regulator to the drive unit.

The movement or rotation implemented by the drive unit (e.g., by the drive unit alone) may involve movement or rotation in which an operator does not apply any forces directly for moving and/or rotating the platform (for example, apart from the force that is exerted on the actuation element for the actuation thereof). An omnidirectional electrical drive unit may include an electrical drive unit that permits (e.g., any movement maneuver) movement maneuver within a plane (for example, without being equipped with a mechanical steering mechanism).

In at least some exemplary embodiments, an operator may move the table in any desired direction without applying force, and thus in an ergonomically advantageous manner The operator may actuate the actuation element (e.g., actuate the actuation element alone), and the floor platform may be moved appropriately automatically via the electrical drive unit. A simple and intuitive regulation may thereby be provided, which allows the floor platform and thus an operating table to be moved easily (for example, without a significant learning curve by a user).

In at least some exemplary embodiments, the drive unit may comprise a plurality of independently actuable, actively driven wheels. The regulator may regulate these wheels individually, based on the actuation of the actuation element, whereby the direction of movement and/or the speed of movement of the floor platform may be specified (e.g., predetermined). The driving of the various driven wheels at different speeds may allow rotational movements and/or cornering to be realized, for example, without requiring an external application of force to the floor platform and/or mechanical steering of the floor platform for this purpose.

In at least some exemplary embodiments, the drive unit may comprise at least one non-electrically-driven support wheel, in addition to the driven wheels. The support wheel may be moved along by its contact with the floor, solely by the movement of the floor platform, and is thus for example passively driven. Additional support wheels nay provide a relatively secure footing of the floor platform on the floor, and may allow relatively greater forces to be transmitted. The support wheel can be, for example, a swivel castor, a ball castor, a non-driven Mecanum wheel and/or a slide pad. Also for example, the support wheel may be configured such that it can swivel, and may thus be (e.g., automatically) oriented in the direction of movement of the floor platform.

The longitudinal axes of the driven wheels, around which the wheels may rotate, may be positioned, for example, rotationally fixed in relation to the floor platform. In at least some exemplary embodiments, a mechanical steering mechanism for the wheels may not be involved, because alignment of the wheels relative to the floor platform remains substantially the same (for example, substantially always remains the same).

The drive unit may have, for example, at least one electric motor for driving the driven wheels.

In at least some exemplary embodiments, a plurality of electric motors may be provided, with one electric motor for example being assigned to each driven wheel, and each electric motor being used (e.g., exclusively used) for driving the respective wheel to which it is assigned. It is thereby achieved, in a relatively simple manner, that each wheel can be driven at an individual speed, which may help facilitate omnidirectional movements of the floor platform.

In at least some exemplary embodiments, a single electric motor may be provided, which may be connected via appropriate coupling units to all or to a plurality of driven wheels (or a single wheel), these coupling units being configured such that said motor can drive the various wheels at different speeds.

In at least some exemplary embodiments, the drive unit may comprise four electrically driven Mecanum wheels. An omnidirectionally movable floor platform may thereby be provided in a relatively simple manner, which can be moved within the floor plane in some or substantially all directions and can be rotated about any axis that is orthogonal to this plane.

In at least some exemplary embodiments, two Mecanum wheels may be arranged coaxially. For example, the two axes, on each of which two of the Mecanum wheels may be disposed, are in turn arranged parallel to one another, so that the Mecanum wheels are arranged at for example the corners of a quadrilateral. A relatively stable footing may thereby be achieved.

In at least some exemplary embodiments, the drive unit may comprise four hub drives, with each hub drive being used to drive for example one Mecanum wheel. This may allow each hub wheel to be driven individually in a relatively simple manner In at least some exemplary embodiments, each of the hub drives may be configured with or without a separate brake.

In at least some exemplary embodiments, some or all (e.g., each) of the hub drives may be arranged coaxially to the associated Mecanum wheel, so that a relatively complex gear transmission between the output shaft of the hub drive and the Mecanum wheel may not be included. Alternatively, the hub drives may also not be arranged coaxially with the Mecanum wheels.

In at least some exemplary embodiments, each of the Mecanum wheels (or for example some or all of the wheels) may be mounted on an independent suspension. This may provide for four (or for example some or all) Mecanum wheels to undergo or experience substantially the same traction on the floor. This may provide for targeted movement in a desired direction.

In an alternative embodiment of the invention, in place of independent suspensions, two of the Mecanum wheels can be mounted on a swing axle, with the other Mecanum wheels being mounted on a substantially rigid axle. The swing axle may be configured such that it is arranged pivotably in relation to a base member of the floor platform, for example to a housing, while the rigid axle may be non-pivotably attached to the base member. This combination of a swing axle and a rigid axle may allow for uneven floor surfaces to be adequately compensated for, and may give some or all (for example, all four) Mecanum wheels the same traction on the floor.

In an alternative embodiment of the invention, the drive unit can additionally or alternatively also comprise for example three omnidirectional wheels. These omnidirectional wheels may allow the floor platform to be moved and rotated in substantially any direction in a relatively simple manner (for example without a steering mechanism and without the influence of external forces) by actuating the respective omnidirectional wheels individually.

An omnidirectional wheel may be, for example, a wheel whose running surface may comprise rollers, the rotational axes of which may be aligned perpendicular to the rotational axis of the main wheel.

The omnidirectional wheels may be arranged, for example, in such a way that the longitudinal axes of the omnidirectional wheels (e.g., the axes about which the main wheel may be rotated) intersect at a common point.

In at least some exemplary embodiments, any suitable type of wheel may be used in addition to Mecanum wheels or omnidirectional wheels. For example, actively driven swivel castors may be provided in the drive unit.

In at least some exemplary embodiments, at least one lifting unit may be provided, by which the drive unit can be moved relative to the underside of the floor platform. For example, the lifting unit can be used to move the wheels of the drive unit between a moving position and a stationary position, in which case, in the moving position the wheels are arranged such that they protrude from the underside of the floor platform and may thus be in contact with the floor. In the stationary position, for example, the wheels may be arranged such that they do not protrude from the underside, so that the floor platform may rest with its underside on the floor, and a relatively secure footing may be achieved. For example, the lifting unit may provide for some or all the wheels of the floor platform (for example, both the driven and the non-electrically-driven wheels) to be adjusted in terms of height. For example, when the floor platform is not moved, a relatively more secure footing of the floor platform, and thus of the operating table, is provided (for example, secure footing on rigid base members).

The lifting unit can be driven, for example, fluidically and/or electromechanically.

In at least some exemplary embodiments, some or all (for example, each) of the wheels of the drive unit may be arranged within a wheel guard. For example, the wheels may be protected. Also based on the wheel guard, for example, operators may not come into contact with the rotating wheels.

In at least some exemplary embodiments, a wheel guard (e.g., each wheel guard) may be equipped with a port for a cleaning device for cleaning the wheels. For example, this port can be a port for a rinsing device, with which the wheel guards and the wheels arranged in them can be rinsed. This may provide for a suitable level of hygiene for operating tables to be provided in a relatively simple manner.

In at least some exemplary embodiments, the control unit may include a direction sensor, which may determine the actuation direction of the actuation element. The regulator may regulate the drive unit, in accordance with the determined direction of movement of the actuation element, in such a way that the drive unit moves the floor platform in this direction of actuation. For example, the direction vector of the actuation of the actuation element and the direction vector in which the floor platform is being moved may coincide. For example, intuitive regulation by an operator may be provided in a relatively simple manner, because the operator may move the actuation element in the direction in which the floor platform is to move.

In at least some exemplary embodiments, the control unit may include a force/moment sensor that detects the force and/or the moment with which the actuation element is actuated in the actuation direction. The regulator may determine the speed at which the drive unit is moving the floor platform in the actuation direction, on the basis of the determined force and/or the determined moment, for example with the speed being proportional to the determined force or to the determined moment.

For example, the direction of movement and/or the speed of movement can be determined intuitively by an operator, for example without a significant learning curve.

In at least some exemplary embodiments, the regulator may trigger the drive unit when moment is exerted on the actuation element, in such a way that the floor platform may be rotated about an axis of rotation that coincides with the longitudinal axis of the actuation element. Intuitive regulation may thereby be provided, because the floor platform may not rotate about a fixed axis (e.g., the center axis of the floor platform) and instead may rotate at the point where the control element is also located. For example, the control element may be designed such that it can be attached at various locations on the floor platform and/or the operating table, thereby (e.g., constantly) providing intuitive regulation.

In at least some exemplary embodiments, when moment is exerted on the actuation element, the drive unit can also trigger the regulator in such a way that the regulator always rotates the floor platform about a predefined axis of rotation, independently of the position of the control unit. This predetermined axis of rotation may be, for example, the vertical center axis of the floor platform, which may coincides, for example, with the longitudinal axis of a column (above which, for example, the patient support unit can be secured at the interface with the floor platform).

In at least some exemplary embodiments, the control unit may be embodied as a separate unit that can be secured to the floor platform and/or to a removably attachable patient support unit that can be secured to the floor platform, and can also be detached therefrom. This may allow the control unit to be secured and/or maintained in an ergonomically advantageous position, based on the position of the operator relative to the floor platform or the operating table.

For example, the control unit can be secured at one or more predetermined interfaces. These interfaces may be configured, for example, such that the alignment of the control element relative to the operating table or the floor platform may be predefined (e.g., predetermined), allowing the direction of actuation and the direction of movement to be matched in a relatively simple manner.

In at least some exemplary embodiments, the control unit and/or the floor platform may have a position sensor unit for determining the positions of the control unit and the floor platform relative to one another. In this manner, even if the control unit is secured at any desired position on the floor platform and/or on an operating table, or even if the control unit is not secured to the floor platform at all, the relative position may be known. For example, it may be possible through a corresponding actuation for the direction of actuation and the direction of movement to coincide, because the regulator appropriately factors in the relative positions of the control unit and the floor platform (which may be determined for example from the position sensor unit) when triggering the electrical drive unit.

In at least some exemplary embodiments, the position sensor unit may comprise at least one ultrasonic sensor, at least one Bluetooth transmitter and/or receiver, at least one infrared transmitter and/or receiver, at least one GPS sensor, WLAN triangulation, indoor positioning, ultrasonic indoor locating and/or ultrasonic indoor positioning.

In at least some exemplary embodiments, the actuation element may be substantially immovable relative to the housing of the control unit. For example, the actuation element may not be moved, and force may be simply exerted in the direction of actuation and/or moment may be exerted in the direction of actuation. This may further enhance the intuitive sense of control of the floor platform, since it may appear to the operator that/she he is moving the floor platform manually, even though the force required for movement is actually being applied by the drive unit.

In at least some exemplary embodiments, the control unit can also be provided such that the direction of actuation and the direction of movement do not coincide in substantially absolute terms. In that case, the various possible directions of movement of the floor platform, for example, may be indicated on the control unit. When the actuation element is actuated in one of the indicated directions of movement, the regulator may regulate the drive unit such that the drive unit moves the floor platform in the direction of movement. For example, a position to which the actuation element is moved in order for the floor platform to move forward (for example, in a predetermined direction of the floor platform) may be indicated on a housing of the control unit. For example, actuating the actuation element to a given position relative thereto allows the floor platform to be controlled in a manner for example similarly to a remote control mechanism for a remote controlled automobile.

In at least some exemplary embodiments, the actuation element may comprise at least one joystick, at least one finger switch, at least one touch panel and/or at least one pedal.

In at least some exemplary embodiments, the actuation element may be provided such that it can be actuated ergonomically for example by both left-handed and right-handed people. For this purpose, it may be configured, for example, as mirror-symmetrical to a center plane of the actuation element.

The control unit may further comprise a release unit, in which case when the actuation element is actuated, the regulator may trigger the drive unit if the release unit is also actuated. This may substantially prevent any unsuitable (e.g., unintended) movement of the floor platform resulting from an inadvertent actuation.

The release unit can, for example, be a switch, e.g., a thumb switch arranged on the actuation element. Additionally or alternatively, the release unit may also have a capacitive sensor for detecting substantially any contact of the actuation element with an electrically conductive object, such as a hand.

In at least some exemplary embodiments, an operating table may comprise a floor platform of the type described above and a patient support unit secured to the floor platform interface. The patient support unit may be connected to the floor platform, for example, via a height-adjustable column.

In at least some exemplary embodiments, the patient support unit may comprise at least one interface for securing the control unit. For example, the patient support unit may comprise at least one rail, for example a plurality of rails, for securing the control unit. For example, the control unit can be attached at any number of suitable locations (for example, depending on which position is favorable for the operator at a given time).

### BRIEF DESCRIPTION OF THE DRAWINGS

Additional features and advantages of the invention will become apparent from the following description which explains the invention with reference to exemplary embodiments, in conjunction with the accompanying figures.

FIG. 1 shows a schematic, perspective view of an exemplary mobile operating table.

FIG. 2 shows a view from the bottom of the exemplary operating table of FIG. 1.

FIG. 3 shows a plan view of the operating table of FIGS. 2 and 3.

FIG. 4 shows a sectional view along line A-A of FIG. 3.

FIG. 5 shows a sectional view along line B-B of FIG. 3.

FIG. 6 shows a schematic, perspective view of an exemplary wheel and a hub drive of the exemplary operating table of FIGS. 1 to 5.

FIG. 7 shows a schematic diagram of a control unit of the exemplary operating table of FIGS. 1 to 6.

FIG. 8 shows a view from the bottom of an exemplary operating table according to another embodiment.

### DETAILED DESCRIPTION AND INDUSTRIAL APPLICABILITY

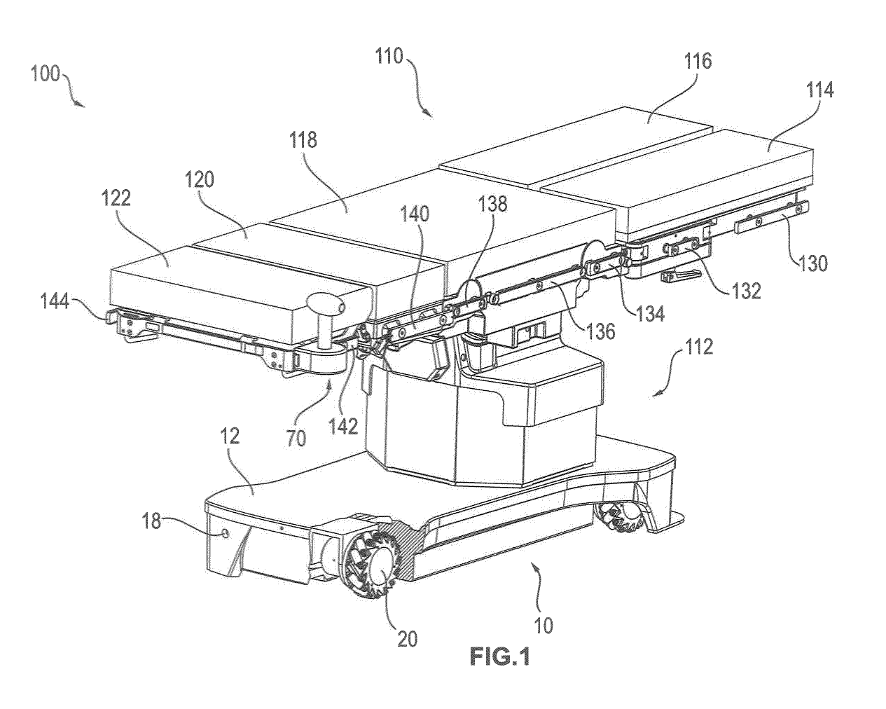

FIG. 1 shows a schematic, perspective view of an operating table 100 that may comprise a floor platform 10 and a patient support unit 110, which may be connected to one another via a column 112. Operating table 100 may be modular in design, for example, and may be composed of patient support unit 110, column 112 and floor platform 10. Column 112 may be configured, for example, such that the height of patient support unit 110 may be adjustable relative to floor platform 10. Patient support unit 110 may comprise a plurality of pads 114 to 122, which may each be adjustable and removable.

Floor platform 10 may be designed as an omnidirectionally movable floor platform 10 that can be moved and rotated, in substantially any desired direction within a predetermined plane (e.g., the plane defined by the floor) by an omnidirectional drive assembly, such as for example an omnidirectional electrical drive unit (for example without a mechanical steering mechanism being provided for this purpose), and may not involve forces being otherwise applied to floor platform 10 and/or to the other parts of operating table 100 for the purpose of steering the table. For example, floor platform 10 may be movable and rotatable by the omnidirectional drive assembly in any direction within a predetermined plane.

In FIG. 1, a portion of a housing 12 of floor platform 10 may be cut away so that the internal parts of the front left-hand corner are visible.

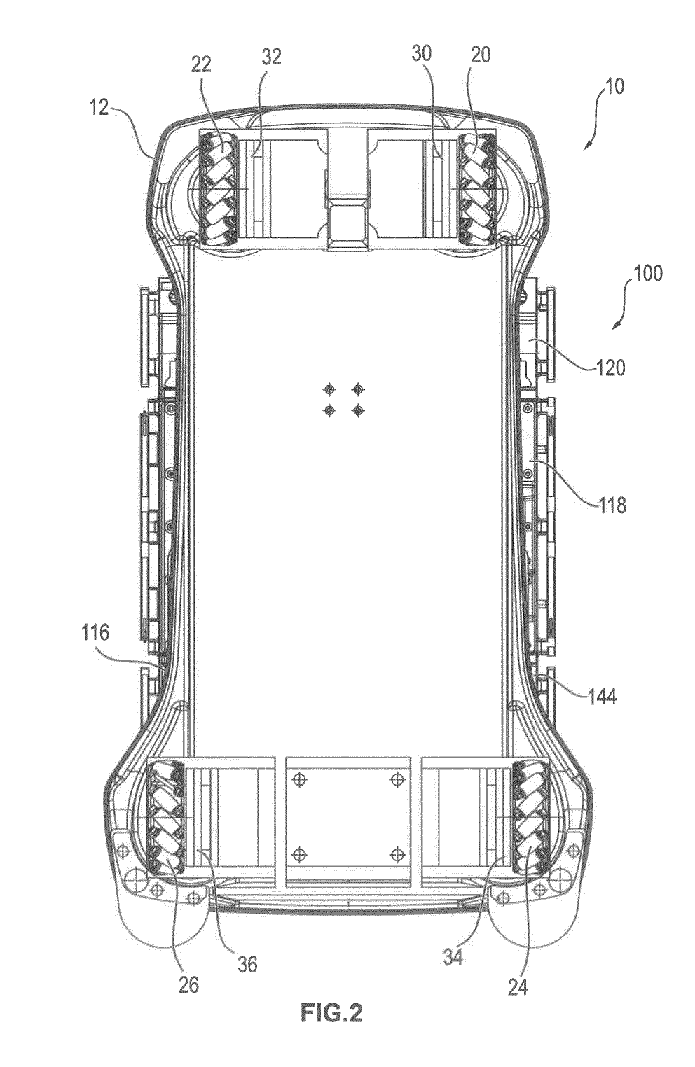

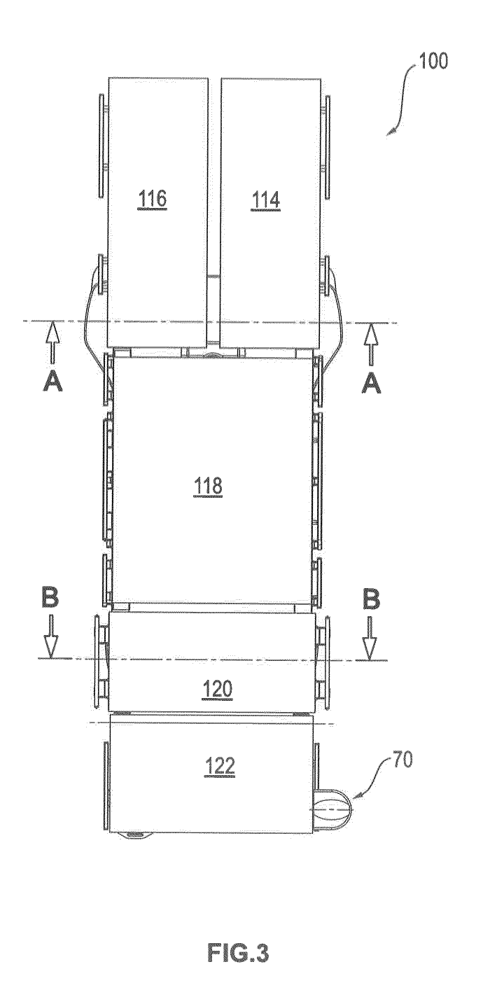

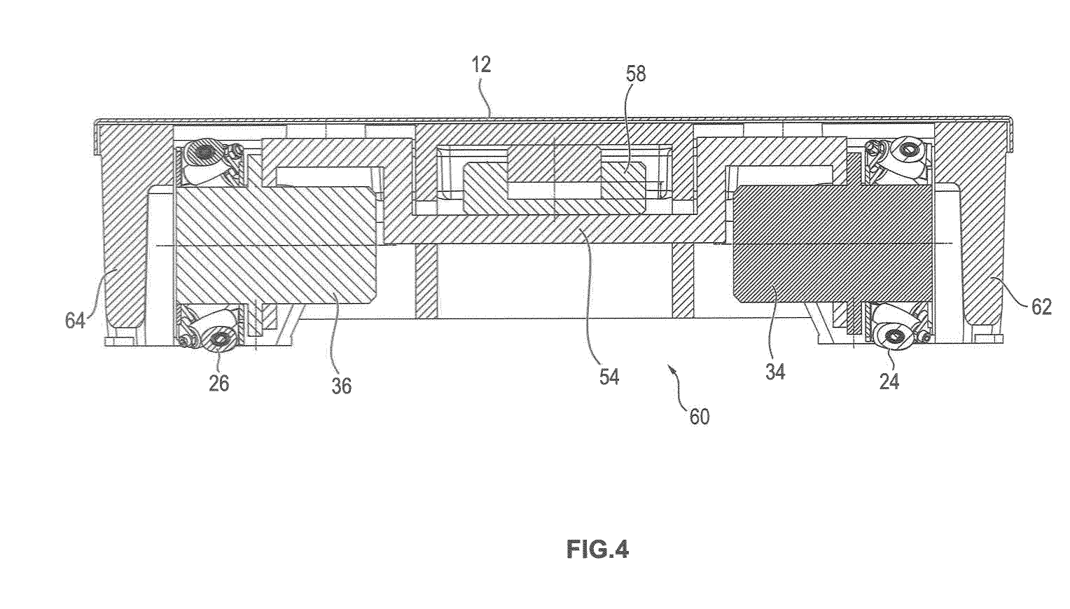

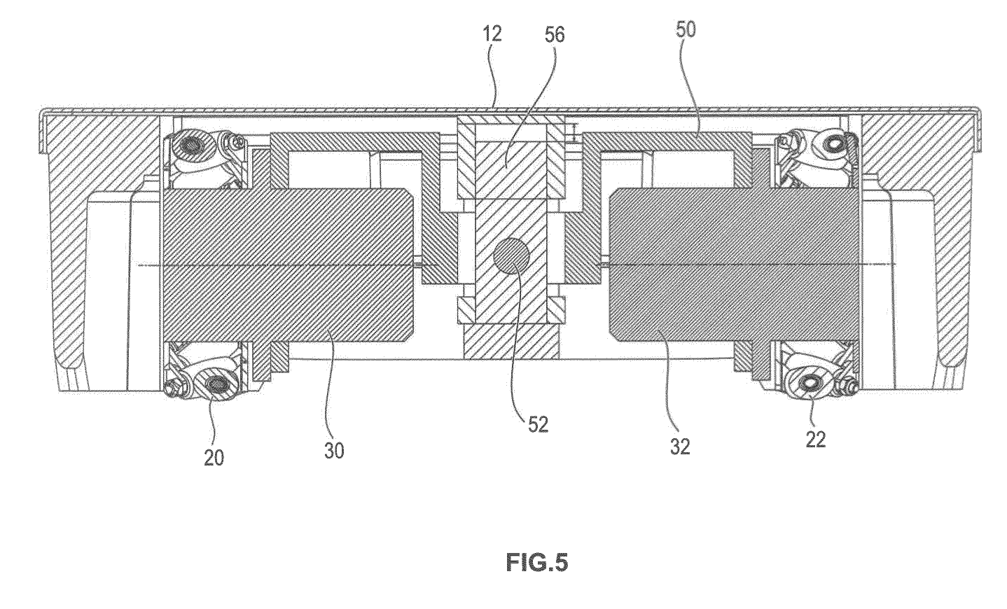

FIG. 2 shows a view from the bottom of operating table 100 of FIG. 1. FIG. 3 shows a plan view of operating table 100, FIG. 4 is a sectional view along line A-A of FIG. 3, and FIG. 5 is a sectional view along line B-B of FIG. 3.

The omnidirectional drive unit of floor platform 10 may comprise any suitable wheels such as four (e.g., Mecanum) wheels 20 to 26, to each of which a hub drive 30 to 36 is assigned, with each hub drive individually driving only the Mecanum wheel 20 to 26 to which it is assigned.

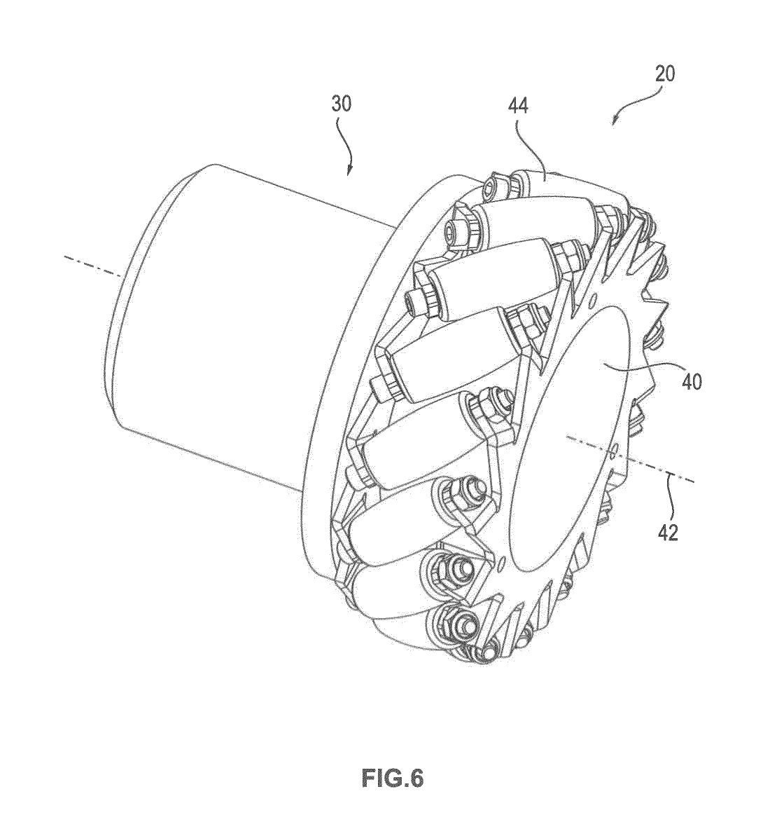

FIG. 6 shows a schematic, perspective view of one of these (e.g., Mecanum) wheels 20, for example with its assigned, coaxially arranged hub drive 30. wheel 20 may have a main wheel 40 that is rotatable about the longitudinal axis 42 of wheel 20, and on the lateral surface of which a plurality of rollers are obliquely and rotatably mounted. One of these rollers may be denoted by way of example by reference sign 44. Main wheel 40 may be actively driven by hub drive 30, whereas the rollers 44 may be driven passively by contact with the floor.

The omnidirectional drive unit may further comprise a regulator that triggers the individual hub drives 30 to 36 independently of one another, and may thus determine the speed at which the individual (e.g., Mecanum) wheels 20 to 26 are driven. Mecanum wheels 20 to 26 may be driven (e.g., controlled) at different speeds in the direction in which the floor platform 10 is moving. For example, floor platform 10 can rotate by also suitably (e.g., appropriately) driving wheels 20 to 26 in place about any vertical axis lying between wheels 20 to 26.

As is shown in FIG. 5, (e.g., Mecanum) wheels 20 and 22, together with the associated hub actuation elements 30, 32, may be mounted on a swing axle 50, which may in turn be rotatably mounted on a pin 52 so that the swing axle, and thus the (e.g., Mecanum) wheels 20, 22 mounted thereon, are able to pivot relative to housing 12 of floor platform 10 about the longitudinal axis of pin 52.

In contrast for example, as is shown in FIG. 4, the other two (e.g., Mecanum) wheels 24, 26 may be mounted on a rigid axle 54, which may not be rotatable relative to housing 12 of floor platform 10.

The result of the combined mounting on a swing axle 50 and on a rigid axle 54 may be that all of wheels 20 to 26 may have approximately the same traction, even on uneven surfaces, thus enabling the intended targeted control. In at least some exemplary embodiments, each of (e.g., Mecanum) wheels 20 to 26 may be mounted on an independent suspension.

Both axles 50, 54 are mounted so as to be vertically adjustable relative to the underside 60 of floor platform 10 by lifting assemblies such as lifting units 56, 58. These lifting units 56, 58 can be used to move wheels 20 to 26 between a stationary position and a movement position; in the stationary position, (e.g., Mecanum) wheels 20 to 26 are raised such that they no longer are in contact with the floor and the floor platform may rest with its feet 62, 64 on the floor.

In the movement position (for example in contrast), Mecanum wheels 20, 26 may be arranged such that they protrude beyond the feet 62, 64 in the direction of underside 60, and may thus be in contact with the floor, allowing floor platform 10 and thus the mobile operating table 100 to be moved by the electrical drive unit.

Housing 12 may be configured such that (e.g., Mecanum) wheels 20 to 26 may be held inside wheel guards, so that they are protected, and any contact with wheels 20 to 26 may be substantially prevented. For example, in housing 12, a cleaning aperture such as a rinsing port 18 may be provided for each wheel guard, through which the wheel guards and thus the (e.g., Mecanum) wheels 20 to 26 arranged within them can be cleaned.

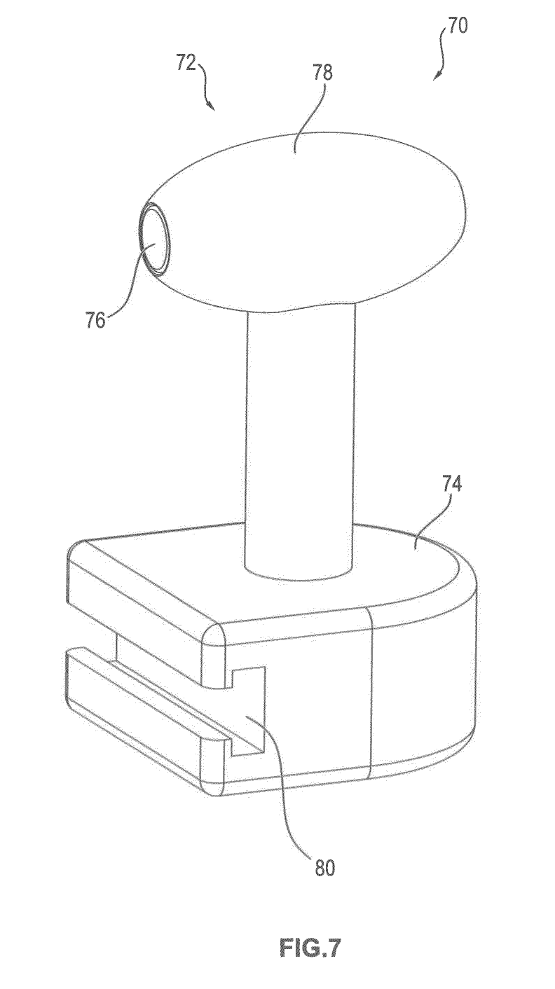

Operating table 100 may further comprise a controller (e.g., control unit 70), a schematic, perspective view of which is shown in FIG. 7.

Control unit 70 may have a manual actuation member such as manually actuable actuation element 72, which may be designed as a type of “stick”. This actuation element 72 may be fixed (e.g., secured or substantially permanently secured) to a housing 74 of control unit 70 and may not be pivoted or rotated relative thereto.

Actuation element 72 may be designed such that it is mirror-symmetrical to a center plane, allowing it to be actuated ergonomically by both left-handed and right-handed operators.

Control unit 70 may have a force/moment sensor, which may be used to determine both the actuation direction in which the actuation element 72 is actuated and the force and the moment with which the actuation element 72 is actuated in the actuation direction.

The regulator may then control (e.g., regulate) the electrical drive unit such that when actuation element 72 is actuated, floor platform 10 moves in the actuation direction, e.g. such that the vector of the force being exerted on the actuation element 72 coincides with the vector of the movement of the floor platform 10. This, for example, may provide for intuitive control.

The speed at which floor platform 10 may be moved in the actuation direction may be proportional, for example, to the force or moment that is exerted on actuation element 72. The additional, (e.g., substantially immovable coupling) coupling of actuation element 72 to housing 74 may further give the operator the feeling of moving floor platform 10 manually, even though he/she may not apply any force to effect this movement, and instead this force may be applied (e.g., solely applied) by the omnidirectional drive unit.

Also provided on the actuation element 72 may be a release member such as a release switch 76, which may be actuated by an operator. For example, if the operator actuates actuation element 72 but does not actuate release switch 76, floor platform 10 will not move.

In at least some exemplary embodiments, such release switches 76 may be arranged at both ends of handle 78 of actuation element 72, so that an operator can actuate release switch 76 with his/her thumb, regardless of which hand is being used to grip handle 78, or from which side.

A plurality of rails 130 to 144 may be provided laterally along patient support unit 110, allowing control unit 70 to be secured at any location on said rails. For this purpose, control unit 70 may be equipped with a recess 80 on housing 74, via which control unit 70 can be slid onto the individual rails 130 to 144. This may allow control unit 70 to be mounted at different locations, depending on which position is suitable for the operator.

In particular, a position sensor unit may be provided, which can be used to determine the position of control unit 70 relative to operating table 100, and for example relative to floor platform 10. The regulator may use (e.g., factor in) the determined relative position suitably (e.g., appropriately) in triggering (e.g., Mecanum) wheels 20 to 26, so that floor platform 10 may always be moved in the same direction in which actuation element 72 is actuated.

In at least some exemplary embodiments, a single specific interface for securing the control unit 70 to patient support unit 110 may be provided. In that case, for example, no position sensor unit may be involved.

Alternatively, it is possible for other types of actuation elements 72 to also be used. In particular, actuation elements that are themselves moved for actuation, such as a joystick, may be used.

Furthermore, in at least some exemplary embodiments, a control unit 70 on which the various movement options for floor platform 100 are indicated may be used. In that case, the movement that is selected via the actuation element may be executed in each case by floor platform 10.

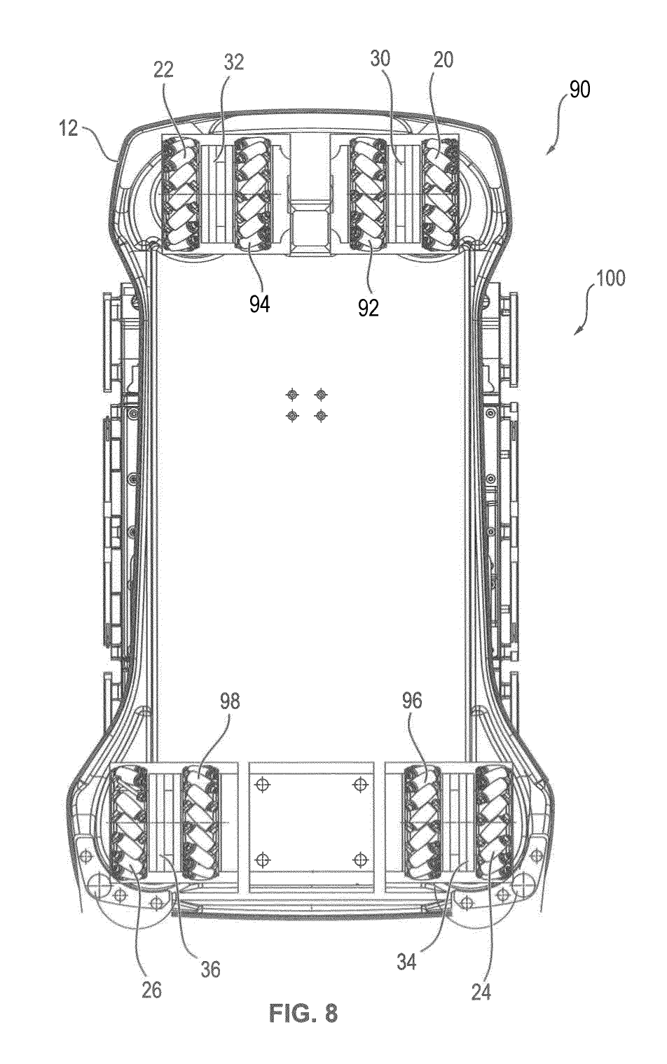

FIG. 8 shows a view from the bottom of a floor platform 90, according to a second exemplary embodiment. Elements that have the substantially same function or the same structure may be denoted by the same reference signs.

This floor platform 90 may for example differ from the floor platform 10 according to the first exemplary embodiment in that four additional (e.g., Mecanum) wheels 92 to 98 may be provided, which may not be actively driven by the electrical drive unit (for example, may not be driven by hub drives 30 to 36) and may instead be driven passively via contact with the floor. These additional wheels 92 to 98 may serve, for example, to distribute the force to a plurality of wheels, so that a weaker force may be applied to the individual (e.g., Mecanum) wheels 20 to 26, and 92 to 98.

In at least some exemplary embodiments, omnidirectional wheels may be used alongside or in place of Mecanum wheels. In that case, it may be suitable, for example, to use three driven omnidirectional wheels.

Also for example, any other form of omnidirectional drive unit that may allow an operator to move floor platform 10, 90 in any direction, without for example a mechanical steering mechanism and/or without the influence of force, may be used.

It will be apparent to those skilled in the art that various modifications and variations can be made to the disclosed method and apparatus. Other embodiments will be apparent to those skilled in the art from consideration of the specification and practice of the disclosed method and apparatus. It is intended that the specification and the disclosed examples be considered as exemplary only, with a true scope being indicated by the following claims.

What is claimed is:

1. An operating table floor platform, comprising:
an omnidirectional drive assembly, which is configured so that the operating table floor platform is movable and rotatable by the omnidirectional drive assembly in any direction within a predetermined plane; and
a controller configured to control the omnidirectional drive assembly;
wherein the controller includes a manual actuation member;
wherein the controller includes a regulator that, based on the actuation of the manual actuation member, determines and sends control signals to the omnidirectional drive assembly; and
wherein the omnidirectional drive assembly moves the operating table floor platform based on the control signals.

2. The operating table floor platform of claim 1, wherein:
the omnidirectional drive assembly includes a plurality of independently actuable, driven wheels; and
the regulator regulates the direction of movement of the operating table floor platform by individually triggering the driven wheels.

3. The operating table floor platform of claim 2, wherein in addition to the driven wheels, the omnidirectional drive assembly includes at least one non-electrically-driven support wheel.

4. The operating table floor platform of claim 2, wherein the longitudinal axes of the driven wheels, about which the wheels rotate, are arranged non-rotatably relative to the operating table floor platform.

5. The operating table floor platform of claim 2, wherein the omnidirectional drive assembly includes a plurality of electric motors, each driven wheel being assigned an electric motor, and each electric motor being used exclusively for driving the wheel to which it is assigned.

6. The operating table floor platform of claim 1, wherein the omnidirectional drive assembly includes four electrically driven Mecanum wheels, each of the Mecanum wheels being mounted on an independent suspension.

7. The operating table floor platform of claim 6, wherein the omnidirectional drive assembly includes four hub drives, each of the four hub drives being arranged coaxially with the Mecanum wheel that is driven by the respective hub drive.

8. The operating table floor platform of claim 6, wherein:
a first pair of the Mecanum wheels is mounted on a swing axle that is pivotable relative to a base member of the operating table floor platform; and
a second pair of the Mecanum wheels is mounted on a rigid axle that is non-rotatably attached to the base member.

9. The operating table floor platform of claim 1, further comprising:
at least one lifting assembly configured to move a plurality of wheels of the omnidirectional drive assembly relative to an underside of the operating table floor platform;
wherein in a movement position, the plurality of wheels are disposed such that they protrude outward from the underside; and
wherein in a stationary position, the plurality of wheels are disposed such that they do not protrude outward from the underside.

10. The operating table floor platform of claim 1, wherein:
each of a plurality of wheels of the omnidirectional drive assembly is disposed in a wheel guard; and
each wheel guard has a cleaning aperture.

11. The operating table floor platform of claim 1, wherein:
the controller includes a direction sensor that determines the actuation direction of the manual actuation member; and
the regulator triggers the omnidirectional drive assembly based on the determined actuation direction so that the omnidirectional drive assembly moves the operating table floor platform in a direction of actuation.

12. The operating table floor platform of claim 1, wherein:
the controller includes a force/moment sensor that detects a force or a moment with which the manual actuation member is actuated in an actuation direction;
the regulator determines the speed at which the omnidirectional drive assembly will move the operating table floor platform in proportion to the detected force or the detected moment and triggers the omnidirectional drive assembly accordingly; and
when a moment is exerted on the manual actuation member, the regulator triggers the omnidirectional drive assembly in such a way that the omnidirectional drive assembly rotates the operating table floor platform about a rotational axis either that coincides with the longitudinal axis of the manual actuation member or that is a vertical center axis of the operating table floor platform.

13. An operating table floor platform, comprising:
a drive assembly, which is configured so that the operating table floor platform is movable and rotatable by the drive assembly in any direction within a predetermined plane; and
a controller configured to control the drive assembly;
wherein the controller includes a manual actuation member;
wherein the controller includes a regulator that, based on the actuation of the manual actuation member, determines and sends control signals to the drive assembly;
wherein the drive assembly moves the operating table floor platform based on the control signals;
wherein the drive assembly includes a first pair of wheels and a second pair of wheels;
wherein the first pair of wheels is mounted on a swing axle that is pivotable relative to a base member of the operating table floor platform; and
wherein the second pair of wheels is mounted on a rigid axle that is non-rotatably attached to the base member.

14. The operating table floor platform of claim 13, wherein the controller is a separate assembly that can be secured to the operating table floor platform or to a patient support unit that is removably attachable to the operating table floor platform.

15. The operating table floor platform of claim 13, further comprising a position sensor unit configured to determine a position of the controller and a position of the operating table floor platform relative to one another.

16. The operating table floor platform of claim 13, wherein the manual actuation member is fixed to a housing of the controller.

17. The operating table floor platform of claim 13, wherein:
a plurality of directions of movement of the operating table floor platform are indicated on the controller; and
when the manual actuation member is actuated in a desired direction of the plurality of directions of movement, the regulator triggers the drive assembly so that the drive assembly moves the operating table floor platform in the desired direction.

18. An operating table, comprising:
an operating table floor platform, including
an omnidirectional drive assembly, which is configured so that the operating table floor platform is movable and rotatable by the omnidirectional drive assembly in any direction within a predetermined plane;
a controller configured to control the omnidirectional drive assembly;
wherein the controller includes a manual actuation member;
wherein the controller includes a regulator that, based on the actuation of the manual actuation member, determines and sends control signals to the omnidirectional drive assembly; and
wherein the omnidirectional drive assembly moves the operating table floor platform based on the control signals; and
a patient support unit;
wherein the patient support unit is connected to the operating table floor platform via a height-adjustable column; and
wherein the controller is attached to a rail of the patient support unit.

19. The operating table floor platform of claim 18, wherein:
the controller includes a release member; and
when the manual actuation member is actuated, the regulator triggers the omnidirectional drive assembly when the release member is actuated.

20. The operating table floor platform of claim 19, wherein:
the manual actuation member is a joystick, a finger switch, a touch panel, or a pedal; and
the release member is either a switch disposed on the manual actuation member or a capacitive sensor.
